(19) United States
(12) Patent Application Publication
(10) Pub. No.: US 2007/0102467 A1
(43) Pub. Date: May 10, 2007

(54) EQUIPMENT TRANSPORTATION SYSTEM

(75) Inventors: Troy P. Trulove, Carbondale, CO (US); Justin P. Blanke, Glenwood Springs, CO (US)

Correspondence Address: GLENN L. WEBB, P.O BOX 951, CONIFER, CO, 80433, US

(73) Assignee: KOOP, INC., Glenwood Springs, CO (US)

(21) Appl. No.: 11/164,130

(22) Filed: Nov. 10, 2005

(51) Int. Cl. B60R 9/00; B60R 7/00

(52) U.S. Cl. 224/403; 224/924

(57) ABSTRACT

Systems for securing recreational vehicles to a transport vehicle quickly with a positive engagement mechanism. The systems are also designed to be quickly installed in the transport vehicle without causing any permanent damage to the transport vehicle. The systems may also be quickly changed out to allow other types of recreational vehicles to be transported as well.

### FIELD OF THE INVENTION

This invention relates to the field of systems for securing and transporting equipment in the cargo bed of a transport vehicle.

### BACKGROUND OF THE INVENTION

Personal recreational vehicles, such as motorcycles, snowmobiles and all terrain vehicles have become increasingly popular in recent years. These vehicles are typically transported to a remote site for use via a transport vehicle, such as pick-ups, trucks, trailers, and other types of vehicles. Normally, these transport vehicles are not particularly designed for securely transporting the recreational vehicles. The recreational vehicles must be secured in place on the transport vehicle. The available systems for securing the recreational vehicle range from simple ropes and straps to complex support systems that are permanently mounted on the bed of the transport vehicle.

The use of ropes and straps require extensive rigging to ensure that the recreational vehicle is secure in the transport vehicle. It is difficult to find adequate securing points on both the recreational vehicle and the transport vehicle. Also, these ropes and straps may loosen and cause the recreational vehicle to become insecure in the transport vehicle.

There are accessory systems for securing the recreational vehicle in the cargo bed of the transport vehicle. Unfortunately, these systems are usually permanently mounted to the transport vehicle which may interfere with other uses of the transport vehicle. Also, these systems are usually dedicated to a particular recreational vehicle and not useable with other recreational vehicles.

The prior systems fail to provide a positive engagement mechanism that safely secures the recreational vehicle in the transport vehicle. The prior systems are not able to be quickly and easily removed from the transport vehicle without causing damage to the transport vehicle. The prior systems do not allow the recreational vehicle to be locked safely in the transport vehicle. Also the prior systems do not allow quick changes to the system for other types of vehicles to be secured in the system.

The prior systems typically operate by forcing the shock absorber systems to compress downward to hold the vehicle in place. This creates pressure within the shock absorber systems that causes seals to degrade and leak.

Thus a need exists for a system for securing recreational and other types of vehicles in a transport vehicle without the problems of the prior art systems.

### SUMMARY OF THE INVENTION

The present invention solves these and other problems by providing systems for securing recreational vehicles to a transport vehicle quickly with a positive engagement mechanism. The systems are also designed to be quickly installed in the transport vehicle without causing any permanent damage to the transport vehicle. The systems may also be quickly changed out to allow other types of recreational vehicles to be transported as well.

The present invention in a preferred embodiment includes a positive engagement mechanism that locks the recreational vehicle to the transport vehicle. In one embodiment, the system includes a clip member having engagement teeth that engage a latch mechanism mounted in the transport vehicle. This clip member may be mounted directly onto the recreational vehicle or else mounted onto a locking bar that secures over a portion of the recreational vehicle.

In one preferred embodiment, the system includes a yoke or diamond shaped bracket into which the front wheel of a motorcycle may be engaged and supported. Clip members that are mounted on the motorcycle forks engage in latch mechanisms mounted on this yoke or bracket. The latch mechanisms are resilient to allow the clips members to slide into the latches, then lock in place to prevent the clips from accidentally disengage. A release mechanism, such as a release bar, is activated to allow the clips to disengage at the appropriate time.

In another preferred embodiment, the system includes the clip members mounted onto the motorcycle wheel for engagement into latch mechanisms on the yoke or bracket or other engagement mechanism.

Another preferred embodiment of the present invention mounts the clip members onto the frame of the motorcycle for engagement with a latch mechanism mounted onto the transport vehicle.

The present invention in a preferred embodiment provides a positive engagement locking system for motorcycles and other vehicles. This allows the motorcycle to be securely locked without damaging the shock absorbers.

An additional preferred embodiment of the present invention mounts the clip members as described above onto the foot peg assembly of the motorcycle. The clip members engage in the latch assembly mounted on the transport vehicle.

In another preferred embodiment, the system includes a platform that has a locking bar mounted to it. The end of the locking bar includes a clip member having angled teeth. A latch mechanism is mounted on the platform to engage the clip member to lock the locking bar in place. The locking bar is secured over a portion of the recreational vehicle and locked into place by the clip and latch mechanism.

Another embodiment of the present invention provides an adjustable mechanism for mounting the securing system in the transport vehicle. This adjustable mechanism includes engagement mechanism that engage against the inner sidewalls of the transport vehicle. Alternatively, the system can be bolted to the transport vehicle if there are no sidewalls available.

The system in a preferred embodiment also provides a plurality of spaced mounting holes that allow multiple systems mounted on the transport vehicle. Also, different systems for different vehicles may also be mounted as well.

These and other features of the present invention are evident from the ensuring detailed descriptions of preferred embodiments and from the drawings.

### BRIEF DESCRIPTIONS OF THE DRAWINGS

FIG. 1 is a perspective view of the base platform of a preferred embodiment of the present invention.

FIG. 2 is a perspective view of the engagement mechanism of the base platform of FIG. 1.

FIG. 3 is a perspective view of the assembled mounting system of the embodiment of FIG. 1.

FIG. 4 is a side view of the mounting system of FIG. 3 mounted in a transport vehicle.

FIG. 5 is a perspective view of the securing system of a preferred embodiment of the present invention.

FIG. 6 is a perspective view of the foot release bar of a preferred embodiment of the present invention.

FIG. 7 is a front view of the securing system of FIG. 5.

FIG. 8 is a side view of the securing system of FIG. 5.

FIG. 9 is a perspective view of the securing system of FIG. 5 with the latch mechanism exposed.

FIG. 10 is a front view of the exposed latch mechanism.

FIG. 11 is a perspective view of the clip member of a preferred embodiment of the present invention.

FIG. 12 is a perspective view of the clip member of another preferred embodiment.

FIG. 13 is a side view of the clip member mounted to a motorcycle.

FIG. 14 is a side view of the motorcycle engaged in the securing system.

FIG. 15 is a side view of another preferred embodiment of the present invention.

FIG. 16 is a perspective view of the embodiment of FIG. 15.

### DETAILED DESCRIPTION OF PREFERRED EMBODIMENTS

The present invention provides systems for securely transporting recreational vehicles in the cargo bed of a transport vehicle. Preferred embodiments of the present invention is discussed below with particular relevance to motorcycles, snowmobiles and all terrain vehicles. It is to be expressly understood that this descriptive embodiment is provided for explanatory purposes only and is not meant to limit the scope of the claimed invention. Other types and uses of such systems are also considered to be within the scope of the present invention. For example, the system of the present invention may be used for wheelchairs, mobility systems, bicycles, for golf carts, small tractors, personal watercraft and other types of vehicles.

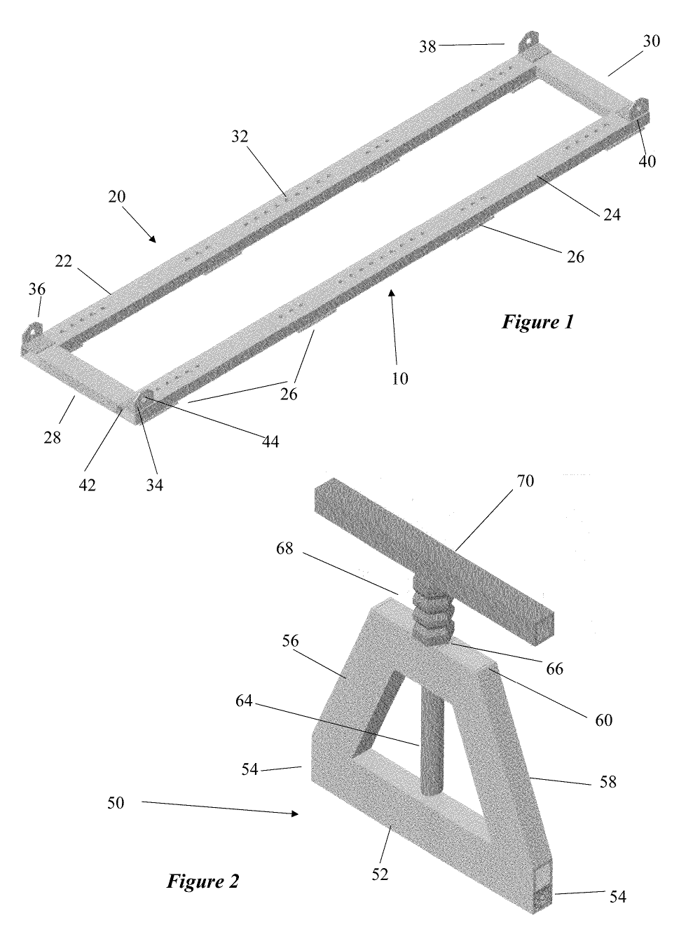

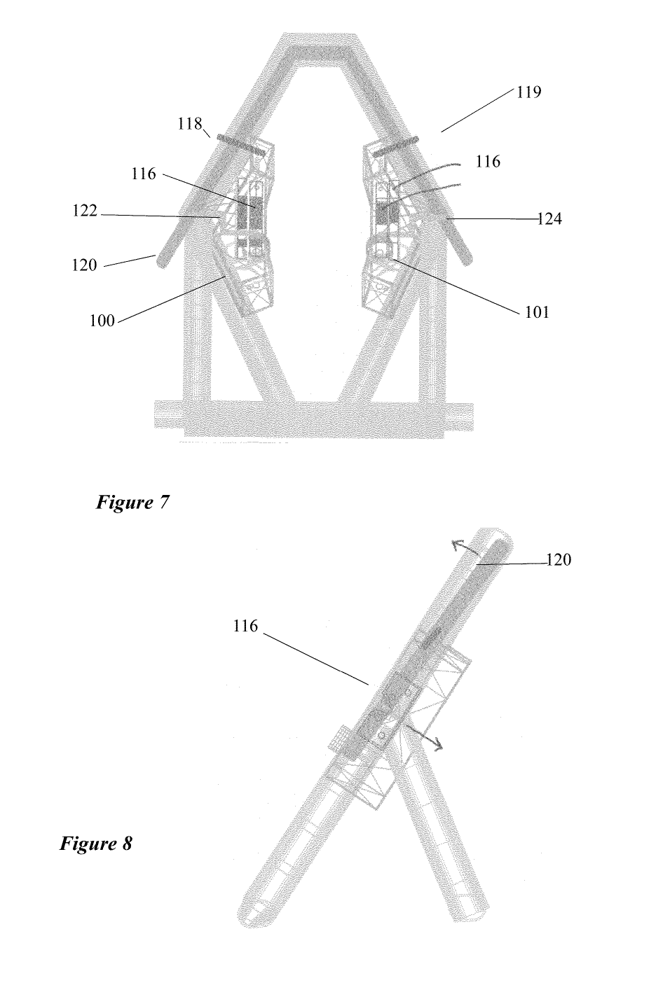

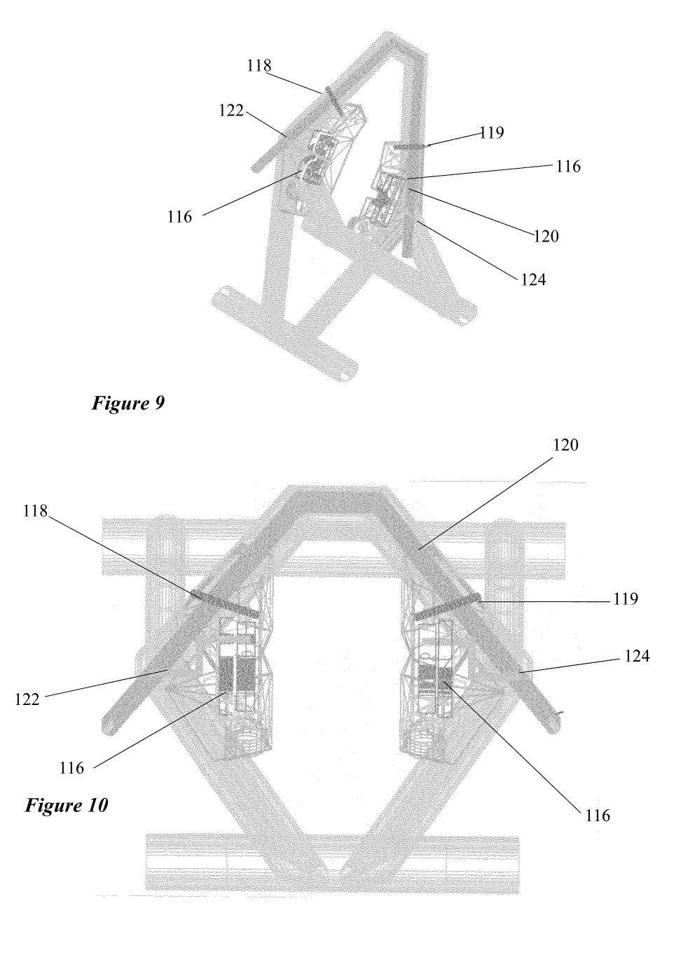

A preferred embodiment of the present invention is illustrated in FIGS. 1-16. This system 10 includes base platform 20 shown in FIG. 1. Base platform 20 includes parallel members 22, 24 that extend just less than the width of most pick-up beds. It is also to be understood that in another embodiment the members 22, 24 are adjustable in their length to accommodate most cargo beds of other transport vehicles. Cross members 28, 30 secure the members 22, 24 to one another. Pads 26 are intermittently mounted to the lower surface of the members 22, 24 to minimize scratching of the cargo bed during use. These pads may be rubber, or any other suitable material.

Spaced holes 32 are formed along each of the members 22, 24 for securing the frames 60 as will be discussed in greater detail below. Brackets 34, 36, 38, 40 are mounted upright to the ends of members 22, 24. These brackets include upright plates 42 with holes 44 formed in those plates.

Engagement mechanisms 50 shown in FIGS. 2-4 are mounted to the base platform 20 to secure the base platform in the cargo bed of a pickup without the need to drill or permanently mount the base platform to the cargo bed or to permanently alter the pickup bed. The engagement mechanisms 50 include base member 52 having internal thread portions 54 on each end. Support members 56, 58 extend upwardly from the base member. Upper portion 60 is attached to these support members. It is to be expressly understood that the shape and configuration of the support members, base member and upper portion can be of any shape or configuration.

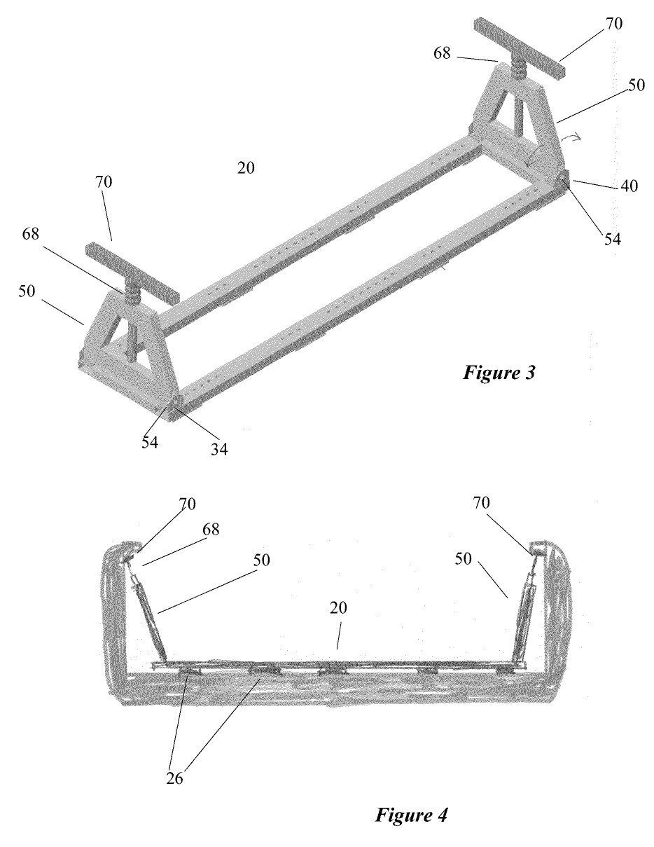

The engagement mechanisms 50 are pivotally mounted to the base platform 20. Bolts engage the internal thread portions 54 on the base member 52 through the holes 44 in the plates 42 on the brackets 40 on the base platforms. This allows the engagement mechanisms 50 to pivot relative to the base platform 20 as shown in FIGS. 3-4.

Threaded rod 64 extends downward into hole 66 formed in the upper portion 60. Nuts 68 are mounted onto the threaded rod 64 above the upper portion. Engagement member 70 is mounted on the upper end of the threaded rod 64.

In use the height of the engagement member 70 can be adjusted by rotation of the nuts 68 in opposing directions. This allows the height of the engagement member 70 relative to the base platform as shown in FIG. 4 to engage the rail surface of the pickup bed to install the base platform 20 in the cargo bed. The nuts can be rotated in the opposing directions to lower the engagement members to remove the base platform from the cargo bed.

It is to be expressly understood that the engagement mechanisms 50 can be eliminated if the base platform is to be permanently installed or installed in the cargo bed of a trailer, flatbed truck or other transport vehicle that may not have a sidewall. Also, other engagement mechanisms may be used as well.

The base platform 20 as discussed above is intended for use with one or more vehicle securing systems. The base platform 20 may be installed in most if not all pick-up cargo beds, flatbeds, trailers, vans, trucks, containers and any other type of transport vehicle.

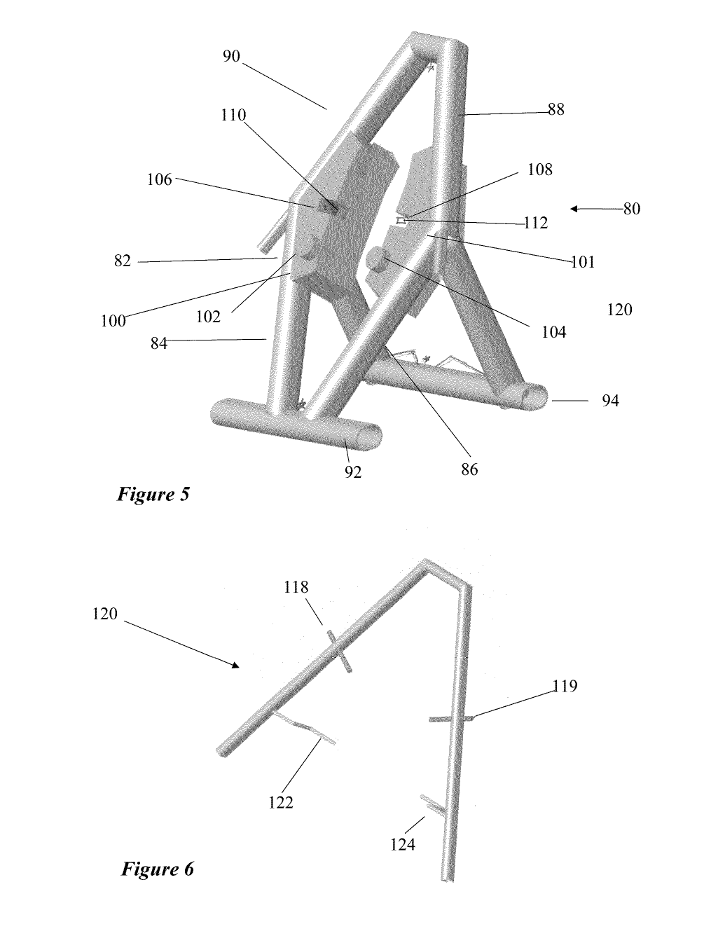

One such securing system is illustrated in FIGS. 5-14. This securing system 80 is intended for motorcycles or other wheeled vehicles. The system 80 includes diamond shaped yoke 82. The sides 84, 86, 88, 90 of the yoke are supported by base members 92, 94. The base members 92, 94 includes mechanisms such as bolts extending through holes formed in the base members that will engage the holes 32 of the base platform 20. The yoke may be secured in the center portion of the base platform or multiple yokes may be mounted on the base platform.

The dimensions of the yoke are selected so that the front wheel of the vehicle will fit inside the inner portion of the yoke with points of contact at the top of the yoke and the base members 92, 94.

Brackets 100, 101 are secured to the center opposing inner portions of the yoke 82. These brackets in this preferred embodiment are formed of plastic, elastomeric, rubber or other durable materials. The brackets 100, 101 are shaped to allow the front wheel of the vehicle to easily but securely roll in between and held there. Protrusions 102, 104 are formed on the front surface of the brackets to dampen the movement of the vehicle as it is engaged in the yoke.

Slots 106, 108 are formed in the brackets 100, 101. Latches 110, 112 are mounted within these slots 106, 108. These latches include teeth 114 that engage clips 130 that are discussed in greater detail below. These latches include hole 116 formed as part of the latch release system. The latch release system includes a foot release pedal 120 that is mounted to the upper yoke arms 84, 86 by axle pins 118, 119. This allows the foot release pedal 120 to pivot relative to the yoke. The foot release pedal extends downward beyond the sides of the yoke.

Offset pin members 122, 124 are mounted to the foot release pedal and extend inward through the brackets 100. The offset portions 126, 128 are mounted into the holes 116 of the latches 110, 112. Thus, when the lower portion of the foot release pedal 120 is pressed inward, the pedal pivots away from the yoke. This causes the offset pin members 122, 124 to move the teeth 114 of the latches 110, 112 away from the clips 130 as discussed in greater detail below.

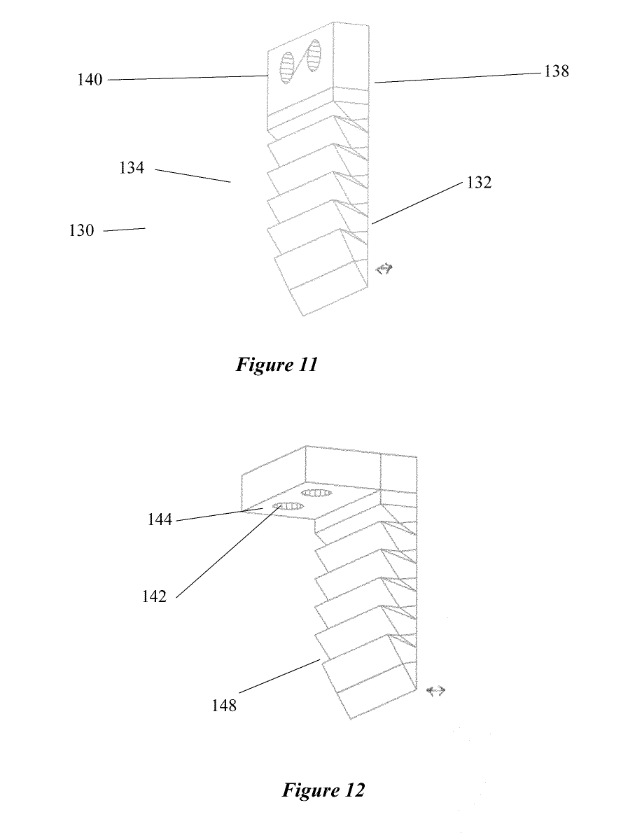

Clips 130 shown in FIG. 11 include flexible members 132 having angular teeth 134. Mounting brackets 136 are formed on the upper end of the clips with mounting holes 138, 140. The mounting holes may be formed in the same plane as the teeth 134 as shown in FIG. 11 or perpendicular to the teeth as shown in FIG. 12 with mounting holes 142, 144 formed in mounting bracket 146 perpendicular with teeth 148. The clips may be metal, plastic or preferably flexible plastic teeth reinforced with metal.

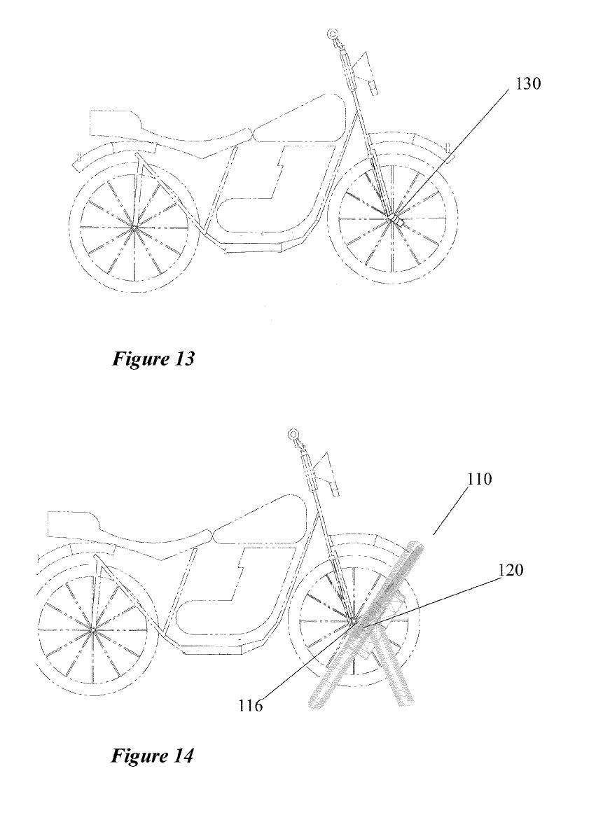

The clips 130 or 150 are mounted to the front forks of the motorcycle as shown in FIG. 13 or other wheeled vehicle. In use, the motorcycle is loaded into the cargo bed of the transport vehicle. The front wheel of the motorcycle or other vehicle is simply rolled into the yoke 82 until the wheel engages the points of contact at the top and bottom of the yoke. The clips 130 engage into the latches 110, 112 on the brackets of the yoke. The latches are resilient mounted so that the impact will not damage them. Thus, the front wheel as well as the rest of the vehicle are securely held in place in the cargo bed of the transport vehicle with the need for additional securement as shown in FIG. 14.

The motorcycle can also be further locked tighter onto the engagement mechanism by pushing or rotating the handlebars in a left to right motion. This pushes the left clip into engagement with the latches and holds it there while the right clip is then pushed into further engagement into its latch. This provides a simple mechanism using the motion of the motorcycle steering mechanism to tighten the motorcycle into even further engagement. It is to be understood that once the clips on the motorcycle are initially engaged in the latch mechanism, the motorcycle is locked securely and safely onto the transport vehicle. This additional engagement provides additional securement from movement of the motorcycle.

When the motorcycle is to be unloaded, pressure is applied to the foot release pedal 120. This is easily done by a rider mounted on the motorcycle. This pressure causes the foot release pedal to pivot away from the yoke and moving the latch away from the clips. This disengages the clips and allows the motorcycle to be rolled away from the yoke.

In another preferred embodiment, the system includes the clip members mounted onto the motorcycle wheel for engagement into latch mechanisms on the yoke or bracket or other engagement mechanism.

Another preferred embodiment of the present invention mounts the clip members onto the frame of the motorcycle for engagement with a latch mechanism mounted onto the transport vehicle.

An additional preferred embodiment of the present invention mounts the clip members as described above onto the foot peg assembly of the motorcycle. The clip members engage in the latch assembly mounted on the transport vehicle.

The clip members may also be attached onto the handlebars of the motorcycle as well. The clip members then engage in the latch assembly on the transport vehicle.

This securement system can be used with many types of wheeled vehicles other than motorcycles, such as bicycles, wheelchairs, scooters, personal vehicles, carts, lawnmowers, small tractors, golf carts and other types of wheeled vehicles.

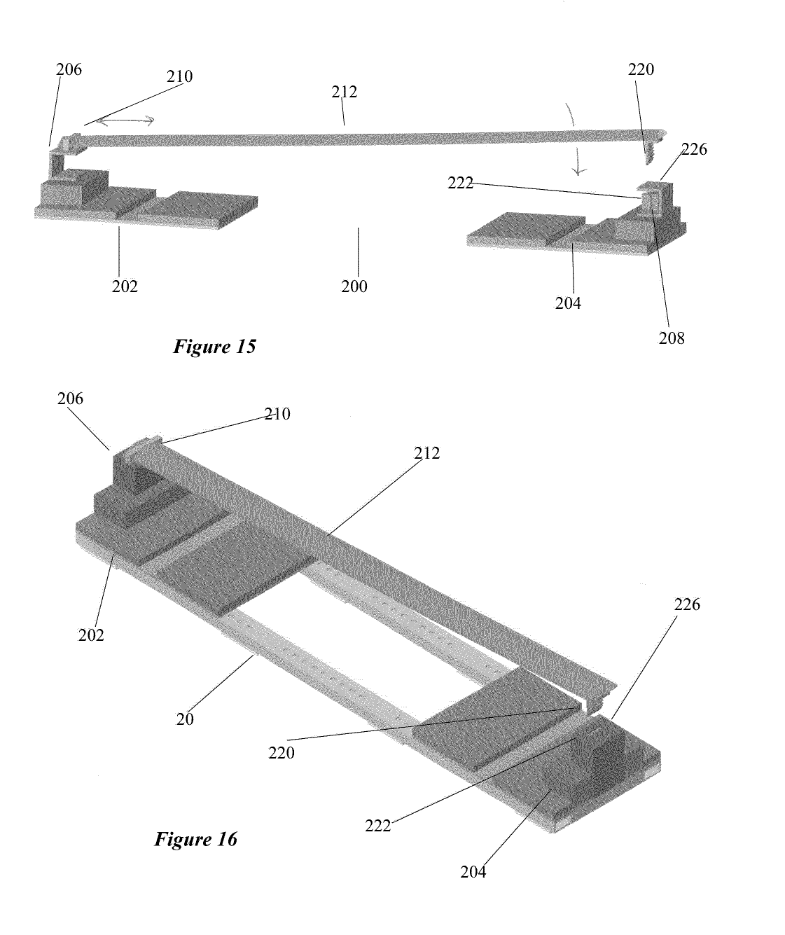

Another securement system 200 is shown in FIGS. 15 and 16. This system is intended for use with snowmobiles and other types of recreational and business vehicles. This system includes base members 202, 204 that are mountable to the base platform 20. The base members may be adjusted relative to one another on the base platform to accommodate different sizes of vehicles. Tower members 206, 208 are mounted on each of the base members. Flexible bracket 210 is mounted on tower member 206. Locking bar 212 is secured to tower member 206 by flexible bracket 206. The locking bar 212 may be pivoted relative to the tower member 206 as well as slid longitudinally.

Clip member 220 is mounted on the opposing end of locking bar 212. Clip member is similar to clip members 130 or 150 discussed above. Latch 222 is mounted within tower member 208. The latch 222 includes teeth 224 that engage the teeth of the clip member 220. An aperture 226 is formed in the tower member 208 above the entry point of the latch 222. The clip member 220 engages through the aperture 226 into latch 222 to lock the locking bar 212 in place over the skis of the snowmobile. This secures the snowmobile in the transport vehicle The latch 222 can be released from the clip member 220 by either a mechanism that releases the latch or a mechanism that moves the clip member away from the latch.

An alternative embodiment of the present system is used for all terrain vehicles. This embodiment is similar to the system 200. A structural arm is mounted to the base platform 20. The structural arm is extendable to be used on differing sizes of vehicles. The arm includes one free hinge and one ratchet hinge that allows it to be adjustable. The arm is locked in place by a clip that engages a latch on the system.

Each of these securing systems can also include locking systems that prevent the latches from being disengaged. This provides an anti-theft component to the systems.

These and other embodiments of the present invention are considered to be within the scope of the claimed inventions.

What is claimed is:

1. A system for securing recreational vehicles relative to a transport vehicle, said system comprising:
a base platform mountable in the transport vehicle;
a securing system mountable on said base platform;
said securing system including a clip member having angled teeth; and
a latch member mounted on said securing system that engages said clip member to secure the recreational vehicle relative to the transport vehicle.

2. The system as set forth in claim 1 wherein said base platform includes:
an adjustable mechanism that enables said base platform to be removably installed in a cargo bed of a transport vehicle without modification of the cargo bed.

3. The system as set forth in claim 1 wherein said base platform includes:
a first adjustable engagement mechanism that engages the underside of a sidewall of a cargo bed of a transport vehicle; and
a second adjustable engagement mechanism that engages the underside of a sidewall of a cargo bed of a transport vehicle;
wherein said first adjustable engagement mechanism and said second adjustable engagement mechanism allows said base platform to be removably installed in the cargo bed without modification of the cargo bed.

4. The system as set forth in claim 1 wherein said securing system includes:
a releasable latch mechanism mounted on said securing system; and
at least one clip mounted to the recreational vehicle that is engaged by said releasable latch mechanism to secure the recreational vehicle to said securing system.

5. The system as set forth in claim 1 wherein said securing system includes:
a yoke that engages over the front wheel of a recreational vehicle;
a latch mechanism mounted on said yoke; and
a clip on the recreational vehicle that is engaged by said latch mechanism to secure the recreational vehicle to said securing system.

6. The system as set forth in claim 1 wherein said securing system includes:
a yoke that engages over the front wheel of a recreational vehicle;
a latch mechanism mounted on said yoke;
a clip on the recreational vehicle that is engaged by said latch mechanism to secure the recreational vehicle to said securing system; and
a release for releasing said latch mechanism to allow said clip to disengage from said latch mechanism.

7. The system as set forth in claim 1 wherein said securing system includes:
a yoke that engages over the front wheel of a motorcycle;
a latch mechanism mounted on said yoke;
a clip on the front forks of the front wheel that is engaged by said latch mechanism to secure the motorcycle to said securing system; and
a release for releasing said latch mechanism to allow said clip to disengage from said latch mechanism.

8. The system as set forth in claim 1 wherein said securing system includes:
a base on said securing system that is mountable on said base platform;
a locking bar pivotally mounted to said base;
a clip on one end of said locking bar; and
a latch mounted on said base to engage said clip to lock said locking bar over a portion of the recreational vehicle to secure the recreational vehicle to said transport vehicle.

9. The system as set forth in claim 1 wherein said securing system includes:
a base on said securing system that is mountable on said base platform;
a locking bar pivotally mounted to said base;
a clip on one end of said locking bar; and
a latch mounted on said base to engage said clip to lock said locking bar over the skis of a snowmobile to secure said snowmobile to said transport vehicle.

10. The system as set forth in claim 1 wherein said securing system includes:
a base on said securing system that is mountable on said base platform;
a locking bar pivotally mounted to said base;
a clip on one end of said locking bar; and
a latch mounted on said base to engage said clip to lock said locking bar over a portion of an all terrain vehicle to secure the all terrain vehicle to said transport vehicle.

11. A system for securing recreational vehicles relative to a transport vehicle, said system comprising:
a clip member having angled teeth;
a mounting mechanism for mounting said clip member on the recreational vehicle; and
a latch member mounted on the transport vehicle that engages said clip member to secure the recreational vehicle relative to the transport vehicle.

12. The system as set forth in claim 11 wherein said system includes:
a yoke that engages over the front wheel of a recreational vehicle; and
said latch mechanism mounted on said yoke.

13. The system as set forth in claim 11 wherein said system includes:
a yoke that engages over the front wheel of a recreational vehicle;
said latch mechanism mounted on said yoke;
said clip on the recreational vehicle that is engaged by said latch mechanism to secure the recreational vehicle; and
a release for releasing said latch mechanism to allow said clip to disengage from said latch mechanism.

14. The system as set forth in claim 11 wherein said system includes:
a yoke that engages over the front wheel of a motorcycle;
said latch mechanism mounted on said yoke;
said clip is mounted on the front forks of the front wheel that is engaged by said latch mechanism to secure the motorcycle; and
a release for releasing said latch mechanism to allow said clip to disengage from said latch mechanism.

15. The system as set forth in claim 11 wherein said system includes:
a base platform mounted on the transport vehicle;
a base that is mountable on said base platform;
a locking bar pivotally mounted to said base;
said clip is mounted on one end of said locking bar; and
said latch is mounted on said base to engage said clip to lock said locking bar over a portion of the recreational vehicle to secure the recreational vehicle to said transport vehicle.

16. The system as set forth in claim 11 wherein said system includes:
a base platform; and
an adjustable mechanism that enables said base platform to be removably installed in a cargo bed of a transport vehicle without modification of the cargo bed.

17. The system as set forth in claim 16 wherein said base platform includes:
a first adjustable engagement mechanism that engages the underside of a sidewall of a cargo bed of a transport vehicle; and
a second adjustable engagement mechanism that engages the underside of a sidewall of a cargo bed of a transport vehicle;
wherein said first adjustable engagement mechanism and said second adjustable engagement mechanism allows said base platform to be removably installed in the cargo bed without modification of the cargo bed.
